(19) United States
(12) Patent Application Publication
(10) Pub. No.: US 2025/0154025 A1
(43) Pub. Date: May 15, 2025

(54) WATER PURIFIER

(71) Applicant: COWAY Co., Ltd., Gongju-si (KR)

(72) Inventors: Si Jun PARK, Seoul (KR); Hyun Suk MOON, Seoul (KR)

(73) Assignee: COWAY Co., Ltd., Gongju-si (KR)

(21) Appl. No.: 18/934,297

(22) Filed: Nov. 1, 2024

(30) Foreign Application Priority Data
Nov. 9, 2023 (KR) 10-2023-0154700

(51) Int. Cl. C02F 1/00; F16K 11/02

(52) U.S. Cl. CPC C02F 1/003; F16K 11/02; C02F 2201/005; C02F 2307/10

(57) ABSTRACT

A water purifier comprises: a flow channel providing a passage through which raw water or purified water flows and having a valve coupling part; a valve unit including one or more valves that are selectively opened and closed to control the flow of raw water or purified water in the flow channel and are detachably connected to the valve coupling part; a valve frame surrounding at least a portion of the valve unit; and a cover part that detachably covers the valve unit and faces one side of the valve unit. The valve unit is exposed to an outside when the cover part is detached.

### TECHNICAL FIELD

The present disclosure relates to a water purifier.

### BACKGROUND

In general, valves of a water purifier are selectively opened and closed to control the flow of raw water or purified water in a flow channel, and are attached to a main frame. A replaceable valve is often placed near a water dispensing unit where the flow paths are concentrated, and a display part is also placed near the water dispensing unit, which makes the placement and replacement of the replaceable valve more difficult. Therefore, when repair or replacement of the valve is required, there has been the inconvenience of requiring a technician to visit the site where the water purifier is installed.

In this regard, Korean Patent Application Publication No. 10-2022-0085318 entitled “Water Purifier” (Patent Document 1) of the applicant “LG Electronics Co., Ltd.” discloses a structure of a water purifier in which a flow path unit can be separated from a valve unit to be replaced.

However, Patent Document 1 only discloses that the flow path module is separated from the valve unit to be replaced, but does not disclose that the valve unit is replaceable, so that it is difficult to replace the valve unit when only the valve unit needs to be repaired or replaced. In other words, in order to replace the valve unit in Patent Document 1, it is necessary to remove the housing and the door body and separate the flow path module to access the valve unit. In addition, in Patent Document 1, the valve unit is fixed to the case cover part, so that there is an inconvenience of needing to separate the valve unit from the case cover part in order to replace the valve unit.

In addition, Korean Patent Application Publication No. 10-2022-0049449 entitled “Water Purifier” (Patent Document 2) of the present applicant discloses a water purifier including a filter and a flow path module that can be directly replaced for the convenience of a user. As disclosed in Patent Document 2, a method for easily directly replacing the filter and the flow path module for the convenience of the user has been studied.

However, patent document 2 only discloses the ease of replacing the filter and the flow path module, but does not disclose that the valve unit is detachable. Apart from the replacement of the filter for filtering raw water and purified water, the valve is also one of the parts that frequently fails, so even if the filter and the flow path module are self-maintained, it is necessary to wait for a technician to replace the valve unit if it breaks down.

### PRIOR ART DOCUMENT

### Patent Document

Patent Document 1: Korean Patent Application Publication No. 10-2022-0085318 (published on Jun. 22, 2022)
Patent Document 2: Korean Patent Application Publication No. 10-2022-0049449 (published on Apr. 21, 2022)

### SUMMARY

In view of the above, embodiments of the present disclosure provide a water purifier including a valve unit that can be easily replaced directly by a user.

In accordance with one embodiment of the present disclosure, the water purifier comprises a flow channel providing a passage through which raw water or purified water flows and having a valve coupling part; a valve unit including one or more valves that are selectively opened and closed to control the flow of raw water or purified water in the flow channel and are detachably connected to the valve coupling part; a valve frame surrounding at least a portion of the valve unit; and a cover part that detachably covers the valve unit and faces one side of the valve unit, wherein the valve unit is exposed to an outside when the cover part is detached.

Further, at least one of the valve unit and the valve coupling part may extend through the valve frame.

Further, the valve unit may be coupled to the flow channel in a direction perpendicular to the cover part.

Further, the water purifier may further comprise a filter unit for filtering raw water to provide purified water, wherein the filter unit may be inserted into the flow channel in the same direction as the direction in which the valve unit is coupled to the flow channel.

Further, the valve unit may include: a valve that may be connected to the flow channel and operates to be opened and closed; and a valve bracket on which the valve may be mounted, the valve bracket having a grip portion formed to protrude in a direction in which the valve unit is detached.

Further, the valve frame may have a hole portion that is smaller in size than the valve coupling part, and the valve unit may further include a connection part extended through the hole portion to be coupled to the valve coupling part.

Further, the cover part may include: a cover member disposed at a front side of a housing to be detachable in a front-rear direction; and a door member disposed inward of the cover member to cover the valve unit and detachably connected to the housing, wherein when the cover member may be detached from the housing, the door member is exposed to the outside, and wherein when the door member may be detached from the housing, the valve unit is exposed to the outside.

According to one embodiment of the present disclosure, the valve unit is provided to be detachable, so that the user can easily replace the valve unit.

In addition, according to one embodiment of the present disclosure, the valve unit is detached or attached in the same direction as the filter unit, so that the user can intuitively replace it directly.

Further, according to one embodiment of the present disclosure, the valve unit can be easily attached by simply pushing it in a direction perpendicular to the cover member, so that the user can conveniently replace it.

Furthermore, according to one embodiment of the present disclosure, the valve grip portion is formed on the valve bracket of the filter unit, so that the user can easily hold the valve unit.

In addition, according to one embodiment of the present disclosure, the valve unit can be supported by the frame by coupling the connection part of the valve unit to the valve coupling part through the valve frame with a hole.

Further, according to one embodiment of the present disclosure, the cover part includes the cover member and the door member, so that the user can access the door member simply by detaching the cover member, and can access the valve unit simply by detaching the door member.

### BRIEF DESCRIPTION OF THE DRAWINGS

FIG. 1 is a perspective view of a water purifier according to one embodiment of the present disclosure.

FIG. 2 is an exploded perspective view of the water purifier in FIG. 1.

FIG. 3 is a cross-sectional view taken along line I-I in FIG. 1.

FIG. 4 is a cross-sectional view taken along line II-II in FIG. 1.

FIG. 5 is a view showing a state where a valve unit is removed from FIG. 4.

FIG. 6 is an enlarged view of part A in FIG. 3.

FIG. 7 is a perspective view of the valve unit in FIG. 3.

FIG. 8 is a rear perspective view of the valve unit in FIG. 7.

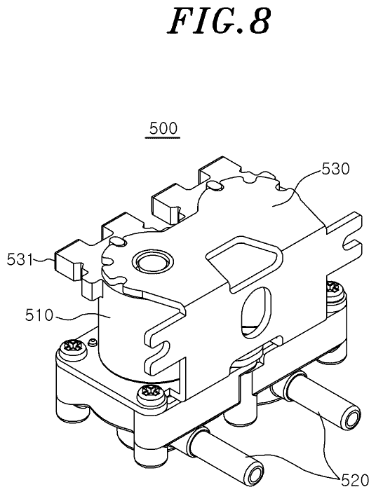

### DETAILED DESCRIPTION

Hereinafter, specific embodiments for implementing the technical idea of the present disclosure will be described in detail with reference to the drawings.

In addition, in describing the present disclosure, when it is determined that detailed descriptions of known configurations or functions may obscure the gist of the present disclosure, the detailed descriptions will be omitted.

Moreover, it should be understood that when a component is referred to as being ‘connected to’, ‘supported by’, or ‘contacted with’ another component, it may be directly connected to, supported by, or contacted with another component, but other components may exist between the components.

The terms used in the present specification are only used for describing the specific embodiments and are not intended to limit the present disclosure. Singular expressions include plural expressions unless the context clearly indicates otherwise.

In addition, in the present specification, expressions such as upper, lower, side, etc. are described based on the drawings, and it is made clear in advance that they may be expressed differently if the direction of the object is changed. For the same reason, some components in the accompanying drawings are exaggerated, omitted, or schematically illustrated, and the size of each component does not entirely reflect the actual size.

Further, terms including ordinal numbers, such as first, second, etc., may be used to describe various components, but the components are not limited by these terms. These terms are only used to distinguish one component from another.

The meaning of “including” and “comprising” used in the present specification specifies specific features, regions, integers, steps, operations, elements and/or components, and does not exclude the presence or addition of other specific features, regions, integers, steps, operations, elements, components, and/or groups.

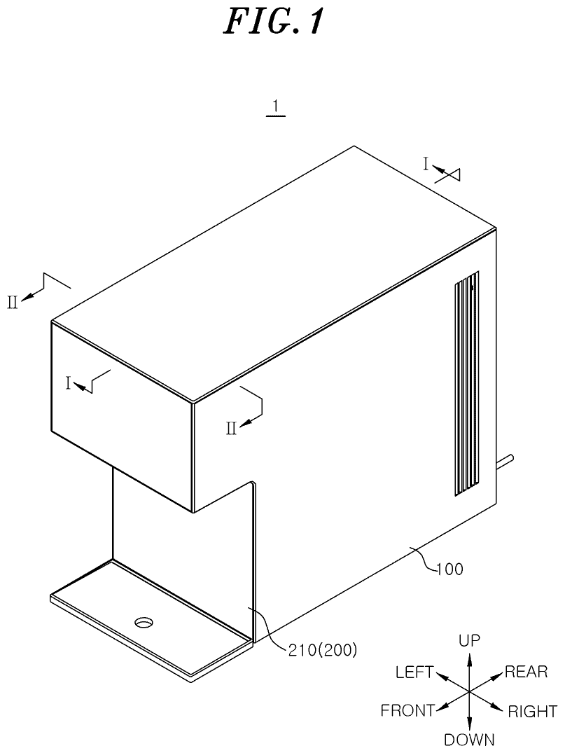

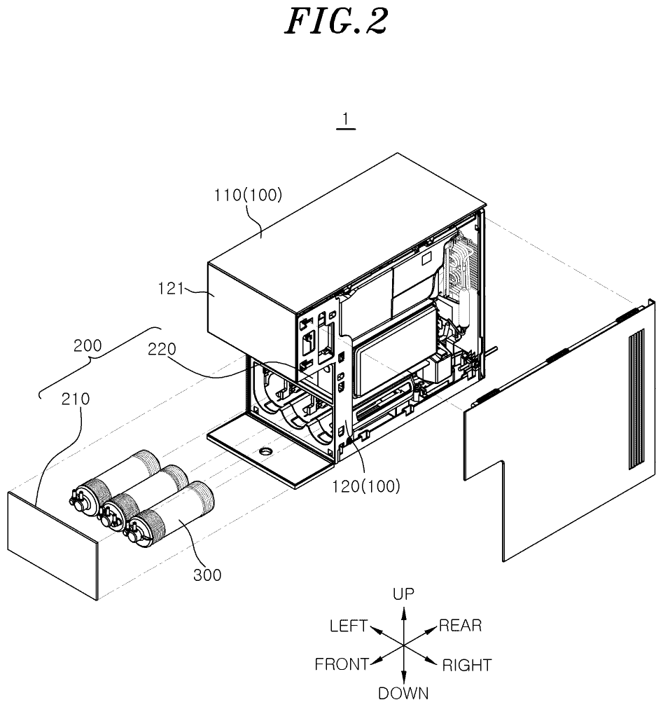

Hereinafter, a specific configuration of a water purifier 1 according to one embodiment of the present disclosure will be described with reference to FIGS. 1 and 2. The water purifier 1 according to one embodiment of the present disclosure can filter raw water and provide purified water to a user. Water that flows into the water purifier 1 from the outside but has not passed through a filter is defined as raw water, while water that has been filtered through the filter is defined as purified water. The water purifier 1 may include a housing 100, a cover part 200, a filter unit 300, a flow channel 400, a valve unit 500, and a frame assembly 600.

The housing 100 may accommodate at least one of the filter unit 300, the flow channel 400, and the valve unit 500 therein. The housing 100 may include a main housing part 110 and a display housing part 120.

The filter unit 300, the flow channel 400, and the valve unit 500 may be arranged inside the main housing part 110. For example, the filter unit 300 and the flow channel 400 may be disposed in an upper portion of an internal space of the main housing part 110, and the filter unit 500 may be disposed in a lower portion of the internal space of the main housing part 110. The main housing part 110 may be disposed at a rear side of the housing 100.

The display housing part 120 may be disposed at a front side of the main housing part 110 to support a display panel 121 to be described later. The display housing part 120 may form the front of the water purifier 1, and the display panel 121 may be provided in the display housing part 120. The display housing part 120 may support the frame assembly 600. The display panel 121 is supported on an upper portion of the display housing part 120, a filter frame 610 to be described later is supported on a lower portion of the display housing part 120, and a valve frame 620 to be described later may be supported between the upper portion of the display housing part 120 and the lower portion of the display housing part 120.

The display panel 121 may display one or more pieces of information about water. For example, the display panel 310 may display one or more of the type of water being dispensed to the outside, the amount of water being dispensed, and the temperature of water being dispensed. As a more detailed example, the display panel 121 may display whether there is an error, whether a filter needs to be replaced, the temperature of purified water, and the type of purified water being dispensed. The display panel 121 may be formed integrally with a button, a touch panel, a dial, and the like to perform a user input function additionally. The display panel 121 may be disposed at the frontmost side of the housing 100 and may be in contact with an edge of the display housing part 120.

The cover part 200 may cover the valve unit 500. The cover part 200 may face one side of the valve unit 500. The cover part 200 can prevent the valve unit 500 from being exposed to the outside from the front side. The cover part 200 may be disposed below the display panel 121. The cover part 200 may include a cover member 210 and a door member 220.

The cover member 210 may be removed from the housing 100 and may cover the valve unit 500. For example, the cover member 210 may be disposed at the front side of the housing to be removable in a front-rear direction. When the cover member 210 is removed from the housing 100, the door member 220 can be exposed to the outside. In order for a user to replace the valve unit 500, the user first needs to remove the cover member 210.

The door member 220 may be detachably connected to the housing 100 to cover the valve unit 500. The door member 220 may be disposed inward of the cover member 210. The door member 220 may be disposed between the cover member 210 and the valve unit 500. In addition, the door member 220 can be positioned closer to the cover member 210 than the valve unit 500. The door member 220 can be removed in the same direction as the direction in which the cover member 210 is removed. For example, when the cover member 210 is configured to be removed in the front-rear direction, the door member 220 may also be configured to be removed in the front-rear direction. The door member 220 may be smaller than the cover member 210. When the door member 220 is removed from the housing 100, the valve unit 500 can be exposed to the outside. In other words, a user can access the door member 220 by detaching the cover member 210 from the housing 100, and can access the valve unit 500 by detaching the door member 220 from the housing 100 to replace the valve unit 500.

The filter unit 300 can filter raw water to provide purified water. The filter unit 300 can be replaced when the purification efficiency decreases due to long-term use. The filter unit 300 may be disposed below the valve unit 500. The filter unit 300 may be inserted into or removed from the filter frame 610 by the user. The filter unit 300 may be inserted into the flow channel 400 in the same direction as the direction in which the valve unit 500 is connected to the flow channel 400.

The flow channel 400 may provide a passage through which at least one of raw water and purified water flows. The raw water may move to the filter unit 300 through the flow channel 400, be filtered by the filter unit 300, and then be discharged through the flow channel 400. Ends of the flow channel 400 may be connected to the valve unit 500 and the filter unit 300. A valve coupling part 410 and a filter coupling part 420 may be provided in the flow channel 400.

The valve coupling part 410 may be an end portion of the flow channel 400 to which the valve unit 500 is coupled. The valve unit 500 may be detachably connected to the valve coupling part 410. As an example, the valve coupling part 410 may be disposed inwardly of the valve frame 620. In other words, the valve coupling part 410 may be disposed on one side of the valve frame 620, and the valve unit 500 may be disposed on the other side of the valve frame 620. As another example, the valve coupling part 410 may extend through the valve frame 620. In other words, rather than a connection part 520 extending through the valve frame 620 to be coupled to the valve coupling part 410, the valve coupling part 410 itself may extend through the valve frame 620 to be coupled to the valve unit 500.

The filter coupling part 420 may be the end of the flow channel 400 to which the filter unit 300 is coupled. The filter unit 300 may be detachably connected to the filter coupling part 420. The filter unit 300 may be coupled to the filter coupling part 420 in a direction perpendicular to the cover part 200. The filter frame 610 may be disposed between the coupled filter unit 300 and the filter coupling part 420.

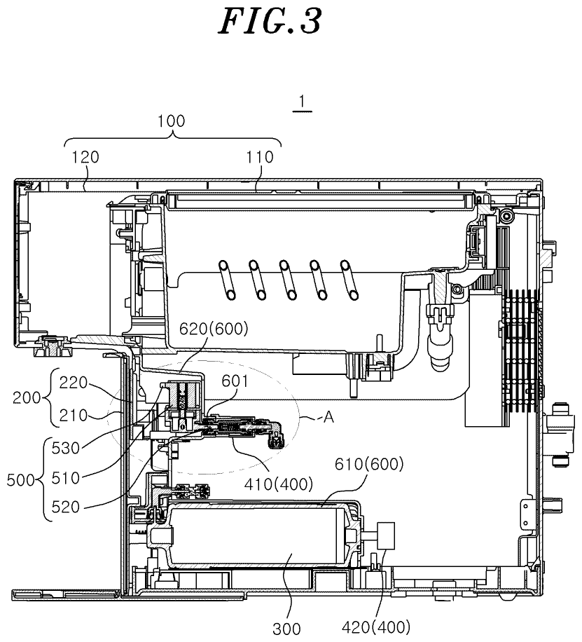

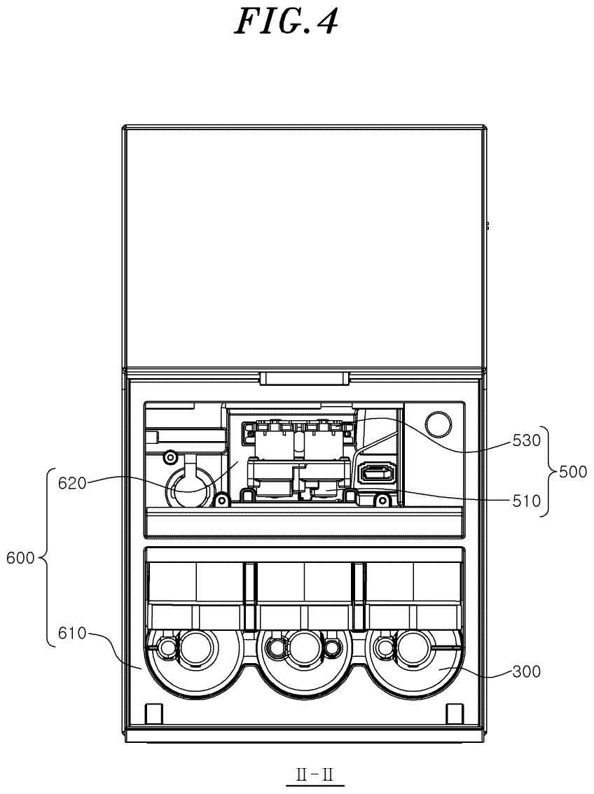

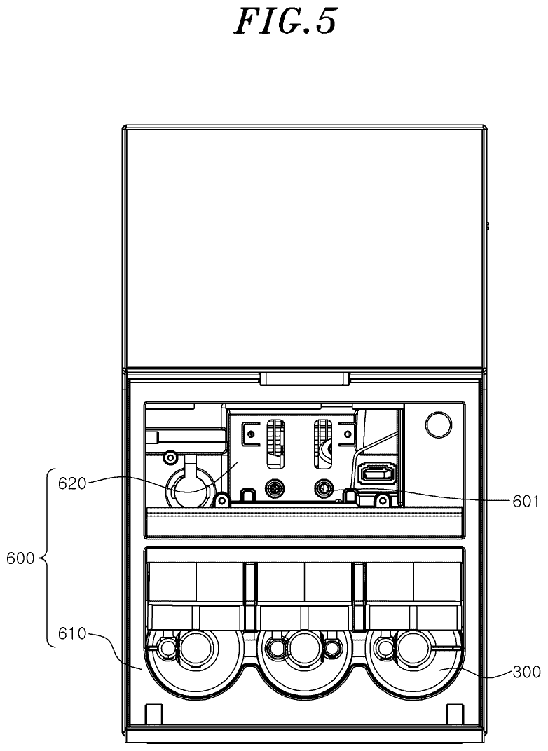

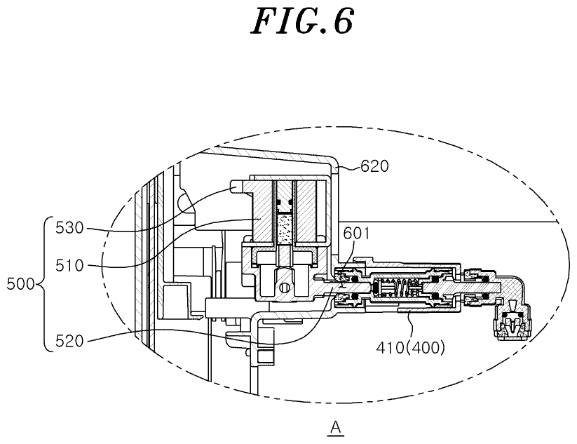

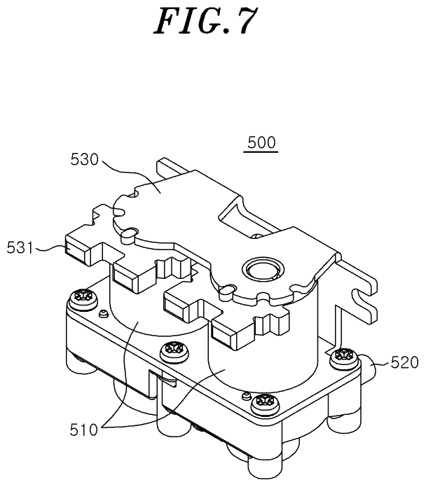

Referring to FIGS. 3 to 7, the valve unit 500 can be selectively opened and closed to control the flow of at least one of raw water and purified water in the flow channel 400. The valve unit 500 may include one or more valves that are detachably connected to the valve coupling part 410. The valve unit 500 may be coupled to the valve coupling part 410 in a direction perpendicular to the cover part 200. The valve unit 500 may include a valve 510, a connection part 520, and a valve bracket 530.

The valve 510 may be connected to the flow channel 400 and operated to be opened and closed. The flow of raw water or purified water in the flow channel 400 can be controlled by the valve 510. A plurality of valves 510 may be provided, and the plurality of valves 510 may be supported on a single valve bracket 530.

The connection part 520 may connect the valve unit 500 to the flow channel 400. The connection part 520 may have a cylindrical shape extending in the front-rear direction. The connection part 520 may extend through the valve frame 620. The connection part 520 may be provided in a plurality. The connection part 520 may be extended through a hole portion 601 to be described later.

The valve 510 may be mounted on the valve bracket 530. The valve bracket 530 may support a plurality of valves 510 so that a user may detach or attach them at once. A portion of the valve bracket 530 may be in contact with the connection part 520. For example, a lower rear portion of the valve bracket 530 may be in contact with the connection part 520. A valve grip portion 531 may be formed on the valve bracket 530.

The valve grip portion 531 may have a shape that protrudes toward the direction in which the valve unit 500 is detached. In other words, when the valve unit 500 is supported by the valve frame 620, the direction in which the valve grip portion 531 protrudes may be the forward direction of the valve unit 500. The valve grip portion 531 may be provided in a plurality. A groove recessed rearward may be formed at a front central portion of the valve grip portion 531.

The frame assembly 600 may support the filter unit 300 and the valve unit 500. The frame assembly 600 may be exposed to the outside when the cover part 200 is detached from the housing 100. When the frame assembly 600 is exposed, the filter frame 610 may be disposed above the valve frame 620. A hole portion 601 may be formed in the frame assembly 600. The frame assembly 600 may include the filter frame 610 and the valve frame 620.

The hole portion 601 may be formed in the valve frame 620. The hole portion 601 may allow the valve unit 500 to extend through the valve frame 620. A diameter of the hole portion 601 may be larger than a diameter of the connection part 520 and smaller than a diameter of the valve coupling part 410. The hole portion 601 may be provided in a plurality. The number of the hole portions 601 may be equal to or larger than the number of the connection parts 520.

The filter frame 610 may surround at least a portion of the filter unit 300. The filter frame 610 may be supported by the display housing part 120. When the filter unit 300 is provided with a plurality of filters, the filter frame 610 may provide a space for accommodating the plurality of filters. The shape of the filter frame 610 may vary depending on the shape of the filter. For example, when the filter has a cylindrical shape, the filter frame 610 may have a cylindrical hole in the center. The filter unit 300 may contact the filter frame 610 to be coupled to the filter coupling part 420 of the flow channel 400. The filter unit 300 may contact the filter frame 610 in a direction perpendicular to the cover member 200.

The valve frame 620 may surround at least a portion of the valve unit 500. For example, the valve frame 620 may cover the front, left, right, top, and bottom sides of the valve unit 500. The valve frame 620 may be supported by the housing 100. The valve frame 620 may be exposed to the outside when the cover part 200 is detached from the housing 100. The valve frame 620 may be disposed above the filter frame 610 and may be disposed in the display housing part 120.

Hereinafter, the operation and effects of the valve unit 500 having the configuration described above will be described.

For easier self-maintenance, the water purifier 1 in which the valve unit 500 is detachable from the flow channel 400 may be provided. Hereinafter, a process for a user to detach the valve unit 500 inside the housing 100 will be described. The user can access the valve unit 500 by detaching the cover part 200. When the cover part 200 includes the cover member 210 and the door member 220, the user can access the valve unit 500 by detaching the cover member 210 and then detaching the door member 220. The user can detach the valve unit 500 by holding the valve grip portion 531 formed at the front of the valve unit 500 and pulling it forward. In this way, the valve unit 500 can be easily separated from the water purifier 1 by the user for repair or replacement without the need for expert assistance.

Hereinafter, a process for the user to attach the valve unit 500 to the interior of the water purifier 1 will be described. The user can detaching the cover member 210 and the door member 220 to allow the valve frame 620 is exposed at the front. The user can attach the valve unit 500 in a direction perpendicular to the cover part 200. When the valve unit 500 is coupled to the valve coupling part 410, the connection part 520 extends through the hole portion 601 to be coupled to the valve coupling part 410 with the larger diameter than that of the hole portion 601, so that the valve unit can be attached to the valve frame 620 without being separated. The connection part 520 is provided on one side of the valve unit 500 so that it can extend through the hole portion 601 to be coupled to the valve coupling part 410. The valve unit 500 can control the flow of water in the flow channel 400 when coupled to the valve coupling part 410.

What is claimed is:

1. A water purifier comprising:
a flow channel providing a passage through which raw water or purified water flows and having a valve coupling part;
a valve unit including one or more valves that are selectively opened and closed to control the flow of raw water or purified water in the flow channel and are detachably connected to the valve coupling part;
a valve frame surrounding at least a portion of the valve unit; and
a cover part that detachably covers the valve unit and faces one side of the valve unit,
wherein the valve unit is exposed to an outside when the cover part is detached.

2. The water purifier of claim 1, wherein at least one of the valve unit and the valve coupling part extends through the valve frame.

3. The water purifier of claim 1, wherein the valve unit is coupled to the flow channel in a direction perpendicular to the cover part.

4. The water purifier of claim 3, further comprising a filter unit for filtering raw water to provide purified water,
wherein the filter unit is inserted into the flow channel in the same direction as the direction in which the valve unit is coupled to the flow channel.

5. The water purifier of claim 1, wherein the valve unit includes:
a valve that is connected to the flow channel and operates to be opened and closed; and
a valve bracket on which the valve is mounted, the valve bracket having a grip portion formed to protrude in a direction in which the valve unit is detached.

6. The water purifier of claim 1, wherein the valve frame has a hole portion that is smaller in size than the valve coupling part, and
wherein the valve unit further includes a connection part extended through the hole portion to be coupled to the valve coupling part.

7. The water purifier of claim 1, wherein the cover part includes:
a cover member disposed at a front side of a housing to be detachable in a front-rear direction; and
a door member disposed inward of the cover member to cover the valve unit and detachably connected to the housing,
wherein when the cover member is detached from the housing, the door member is exposed to the outside, and
wherein when the door member is detached from the housing, the valve unit is exposed to the outside.
